(19) United States
(12) Patent Application Publication
(10) Pub. No.: US 2009/0035039 A1
(43) Pub. Date: Feb. 5, 2009

(54) Tightly integrated serial hybrid printing system

(75) Inventors: James J. Spence, Honeoye Falls, NY (US); Mark S. Amico, Pittsford, NY (US)

Correspondence Address: ALIX, YALE & RISTAS, LLP, 750 MAIN STREET, SUITE 1400, HARTFORD, CT, 06103-2721, US

(73) Assignee: Xerox Corporation

(21) Appl. No.: 11/888,748

(22) Filed: Aug. 2, 2007

(51) Int. Cl. G03G 15/00

(52) U.S. Cl. 399/381

(57) ABSTRACT

An electrophotographic printing machine comprising at least one print engine, an input media path delivering a print media to the print engine, an output media path removing the print media from the print engine, and a media handling transport disposed in at least one of the media paths. The media handling transport includes first and second device halves. Each of the device halves includes first, second and third body members, with the first end portion of the second body member disposed adjacent the first end portion of the first body member, the first end portion of the third body member disposed adjacent the second end portion of the first body member, and the second end portion of the third body member disposed adjacent the second end portion of the second body member. An inner body member defines a first media transport passageway with the second body member define, a second media transport passageway with the third body member, and a third media transport passageway with the first body member. The second end portions of the second and third body members define an abutting end of the device half, with the abutting end of the first device half disposed adjacent the abutting end of the second device half in an installed transport.

### BACKGROUND

This disclosure relates generally to a printing system. More particularly, the present disclosure relates to printing systems having multiple print engines.

Printing systems adapted for use in high speed printing may employ two print engines arranged in tandem to achieve the required print speed. Each print engine prints on one side of the sheet. In this way, duplex prints are formed rapidly and at a high productivity. Each print engine may be an electrophotographic print engine. These print engines are identical to one another and have a photoconductive member that is charged to a substantial uniform potential so as to sensitize the surface thereof. The charged portion of the photoconductive member is exposed to a light image of a document being printed. Exposure of the charged photoconductive member effectively dissipates the charge thereon in the irradiated areas to record an electrostatic latent image on the photoconductive member corresponding to the informational areas desired to be printed. After the electrostatic latent image is recorded on the photoconductive member, the latent image is developed by bringing a developer material into contact therewith. Generally, the electrostatic latent image is developed with dry developer material comprising carrier granules having toner particles adhering triboelectrically thereto. However, a liquid developer material may be used as well. The toner particles are attracted to the latent image, forming a visible powder image on the photoconductive surface. After the electrostatic latent image is developed with the toner particles, the toner powder image is transferred to a sheet. Thereafter, the toner powder image is heated to permanently fuse it to the sheet.

After the toner powder image has been formed on one side of the sheet, the sheet is advanced to the next print engine to have information printed on the other side thereof. The sheet may be inverted or the print engine may be oriented so as to print on the opposed side of the sheet. In any event, both print engines are substantially identical to one another and produce a sheet having information on opposite sides thereof, i.e., a duplex sheet. This is duplex printing. While electrophotographic print engines may be utilized, one skilled in the art will appreciate that any other type of print engines may also be used. For example, ink jet print engines, or lithographic print engines may be used. Furthermore, these print engines may be mixed and matched. Thus, the printing system does not necessarily require only electrophotographic print engines or only ink jet print engines or only lithographic print engines, but rather may have an electrophotographic print engine and an ink jet print engine, or any such combination.

Should either of the print engines become non-operative, the entire print system becomes non-functional. Therefore, print engine down time must be avoided in print shops conducting high volume duplex printing of mission critical customer jobs. One method practiced by print shops to avoid such down time has been to install two printing systems, with one of the printing systems in operation and the other printing system acting as a back-up. While effective, this practice is quite expensive.

U.S. Pat. No. 5,568,246 discloses a printing system including two print engines arranged in tandem. In this printing system, one of the print engines can still be utilized if the other print engines fails, by using the normal single engine duplexing operation. While the disclosed apparatus and methodology provide a cost effective solution, the printing system is dated and does not meet all of the needs of more modern print shops.

### SUMMARY

There is provided an electrophotographic printing machine comprising at least one print engine, an input media path delivering a print media to the print engine, an output media path removing the print media from the print engine, and a media handling transport disposed in at least one of the media paths. The media handling transport comprises first and second device halves, each including first, second and third body members, each having first and second end portions. The first end portion of the second body member is disposed adjacent the first end portion of the first body member, the first end portion of the third body member is disposed adjacent the second end portion of the first body member and the second end portion of the third body member is disposed adjacent the second end portion of the second body member. An inner body member is disposed intermediate the first, second and third outer body members. The inner body member and the second body member define a first media transport passageway, the inner body member and the third body member defining a second media transport passageway, and the inner body member and the first body member defining a third media transport passageway. The second end portions of the second and third body members define an abutting end of the device half. In an installed configuration, the abutting end of the first device half is disposed adjacent the abutting end of the second device half.

The first, second and third body members each have an inner surface extending from the first end portion to the second end portion, each of the inner surfaces defines a guide having a substantially smooth uniform surface. The inner surfaces of the second and third body members each have an arcuate shape to change a direction of travel of a sheet of media substantially ninety degrees. The inner surface of the first body member has a substantially planar shape to maintain the direction of travel of a sheet of media.

The inner body member has a first guide surface extending from a lower end portion to a first upper end portion, a second guide surface extending from the lower end portion to a second upper end portion, and a third guide surface extending from the first upper end portion to the second upper end portion. The first, second and third guide surfaces are disposed opposite to the inner surfaces of the first, second and third body members, respectively and define the first, second and third media transport passageways therebetween.

Each device half further includes a first feed mechanism associated with the first end portion of the first body member and the first end portion of the second body member and a second feed mechanism associated with the second end portion of the first body member and the first end portion of the third body member.

Each device half further includes a first drive mechanism associated with the lower end portion of the inner body member and the inner surface of the second body member, a second drive mechanism associated with the lower end portion of the inner body member and the inner surface of the third body member and a third drive mechanism associated with the inner surface of the first body member and the first guide surface of the inner body member.

Each device half further includes a first diverter extending from a first end portion pivotally mounted proximate to the inner body member lower end portion to a free end disposed adjacent the abutting end of the device half, a second diverter extending from a first end portion pivotally mounted proximate to the inner body member first upper end portion to a free end disposed proximate to the first feed mechanism, and a third diverter extending from a first end portion pivotally mounted proximate to the inner body member second upper end portion to a free end disposed proximate to the second feed mechanism. Where the free end portion of each of the diverters is selectively movable between a first diverter position or a second diverter position by a positioning device.

There is also provided a kit to convert a conventional electrophotographic copying or printing system to an electrophotographic copying or printing system that operates in a tightly integrated parallel printer mode or a tightly integrated serial printer mode. The kit comprises a media handling transport adapted to replace at least one media handling device of the conventional electrophotographic copying or printing system. The media handling transports comprise an upper body member having an inner surface extending from a first end portion to a second end portion. A lower body member has an inner surface extending from a first end portion to a second end portion. A first side body member has an inner surface extending from a upper end portion to a lower end portion. The upper end portion of the first side body member is disposed adjacent the first end portion of the upper body member and the lower end portion of the first side body member is disposed adjacent the first end portion of the lower body member. A second side body member has an inner surface extending from a upper end portion to a lower end portion. The upper end portion of the second side body member is disposed adjacent the second end portion of the upper body member and the lower end portion of the second side body member is disposed adjacent the second end portion of the lower body member. A first inner body member has a first guide surface extending from a lower end portion to a first upper end portion, a second guide surface extends from the lower end portion to a second upper end portion, and a third guide surface extends from the first upper end portion to the second upper end portion. The first guide surface and the first side body member inner surface define a first media transport passageway segment. The second guide surface and the second side body member inner surface define a second media transport passageway segment. The third guide surface and the upper body member inner surface define a first media transport passageway. A second inner body member has a first guide surface extending from an upper end portion to a first lower end portion, a second guide surface extending from the upper end portion to a second lower end portion, and a third guide surface extending from the first lower end portion to the second lower end portion. The first guide surface and the first side body member inner surface define a third media transport passageway segment. The second guide surface and the second side body member inner surface define a fourth media transport passageway segment. The third guide surface and the lower body member inner surface define a second media transport passageway. A first diverter extends downwardly from a first end portion pivotally mounted proximate to the first inner body member lower end portion to a free end. A second diverter extends upwardly from a first end portion pivotally mounted proximate to the second inner body member upper end portion to a free end. The free end portions of the first and second diverters are independently selectively movable between a first diverter position or a second diverter position whereby a sheet of media may be directed from the first media transport passageway segment to the third media transport passageway segment, from the first media transport passageway segment to the fourth media transport passageway segment, from the third media transport passageway segment to the first media transport passageway segment, from the third media transport passageway segment to the second media transport passageway segment, from the second media transport passageway segment to the third media transport passageway segment, from the second media transport passageway segment to the fourth media transport passageway segment, from the fourth media transport passageway segment to the first media transport passageway segment, or from the fourth media transport passageway segment to the second media transport passageway segment.

There is further provided a method of converting a conventional electrophotographic copying or printing system to an electrophotographic copying or printing system that operates in a tightly integrated parallel printer mode or a tightly integrated serial printer mode. The method comprises replacing each of the media handling devices of the conventional electrophotographic copying or printing system with a media handling transport.

### BRIEF DESCRIPTION OF THE DRAWINGS

The present disclosure may be better understood and its numerous objects and advantages will become apparent to those skilled in the art by reference to the accompanying drawings in which:

FIG. 1 is a simplified schematic view of a conventional printing machine;

FIG. 2 is an enlarged view of Area A of FIG. 1;

FIG. 3 is an enlarged view of Area B of FIG. 1;

FIG. 4 is a schematic view of a media transport device half according to the present disclosure;

FIG. 5 is a schematic view of a media handling transport operating in a first configuration;

FIG. 6 is a schematic view of a media handling transport operating in a second configuration;

FIG. 7 is a schematic view of a media handling transport operating in a third configuration;

FIG. 8 is a schematic view of a media handling transport operating in a fourth configuration;

FIG. 9 is a schematic view of a media handling transport operating in a fifth configuration;

FIG. 10 is a simplified schematic view of a printing machine having the media handling transport device of FIG. 5.

FIG. 11 is an enlarged view of Area C of FIG. 10;

FIG. 12 is an enlarged view of Area D of FIG. 10; and

FIGS. 13a, 13b and 13c are schematic views of a pair of the printing machines of FIG. 10 arranged in tandem, showing the printing machines in three modes of operation.

### DETAILED DESCRIPTION

With reference to the drawings wherein like numerals represent like parts throughout the several figures, a tightly integrated serial hybrid printing system in accordance with the present disclosure is generally designated by the numeral 10.

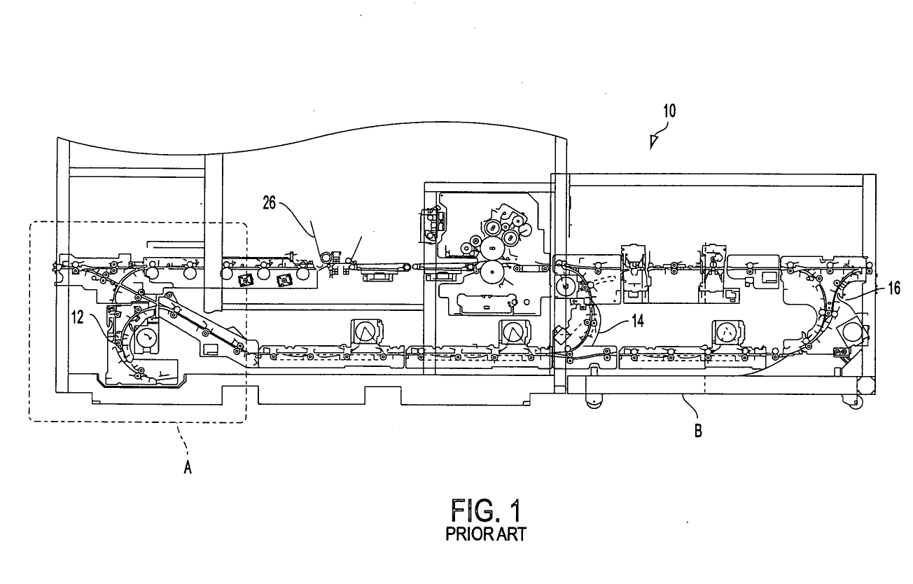

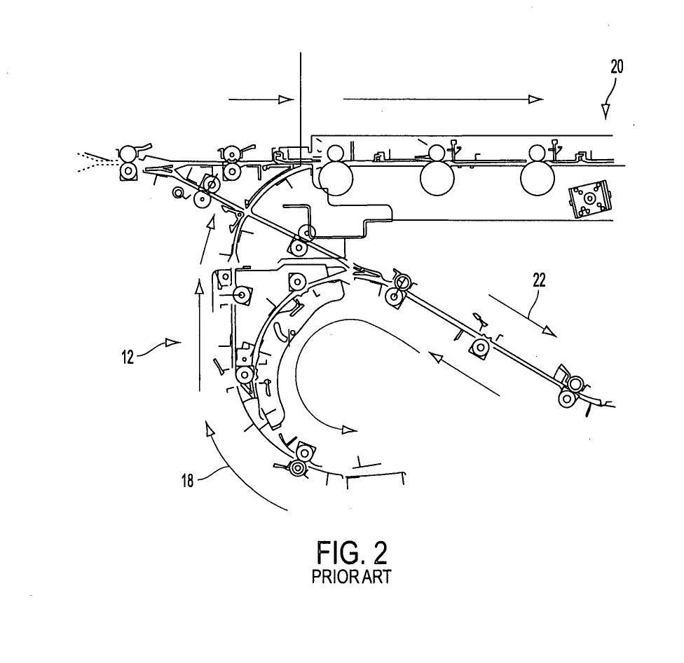

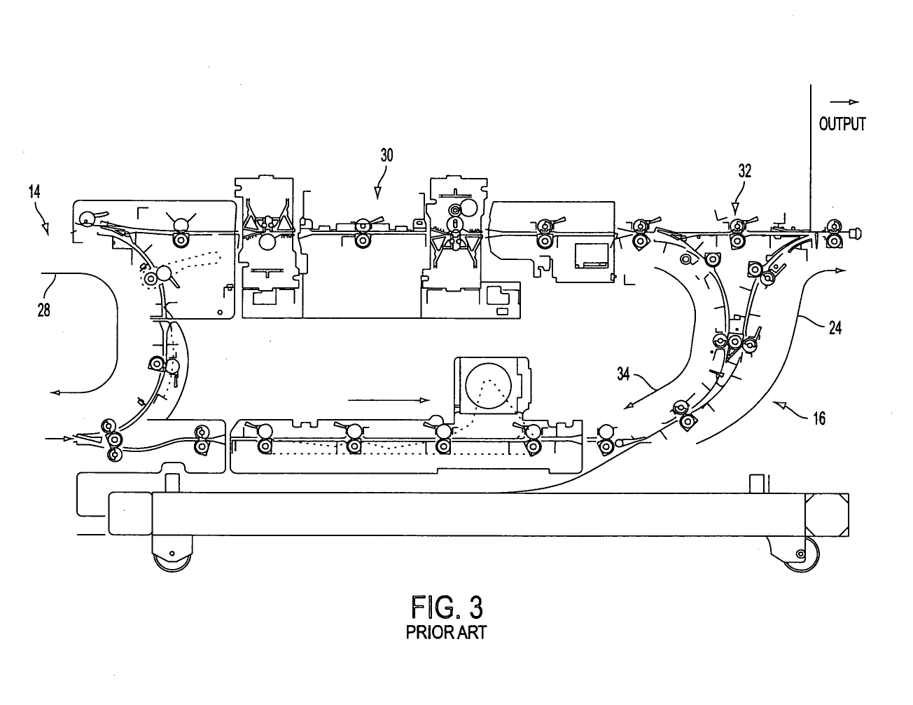

In FIGS. 1, 2 and 3, there is shown, a conventional electrophotographic copying or printing system 10 for processing, printing and finishing print jobs. One example of the illustrated electrophotographic copying system 10 is the well known Xerox Corporation model iGen3™ duplicator. The exemplary copying system 10 includes three media handling devices that are operated by a system controller to direct sheet material on the proper paper path for any given operation of the system 10. The first media handler (registration input and duplex inverter media handling transports) receives new sheet material from a simplex path, and partially processed sheet material from a duplex return paper path. The first media handler either directs the sheet material to the image path or to the bypass path. Sheet material traveling in the bypass path is transported directly through the second media handler (duplex upper and lower turn media handling transports) to the third media handler (output inverter), which then directs the sheet material out of the printing system through the bypass exit. Sheet material traveling in the image path has a first side processed by the image module. The second media handler then either directs the sheet material back to the first media handler, via the duplex return paper path, or to the third media handler, via a transport path. If the sheet material has been fully processed, the third media handler directs the sheet material out of the copying system 10 via an output path. If the second side of the sheet material must be processed, the third media handler directs the sheet material back to the first media handler via the bypass path, thereby inverting the sheet material. While such electrophotographic copying systems 10 are versatile and in wide use, their functionality is limited in that they cannot function in a tandem mode of operation.

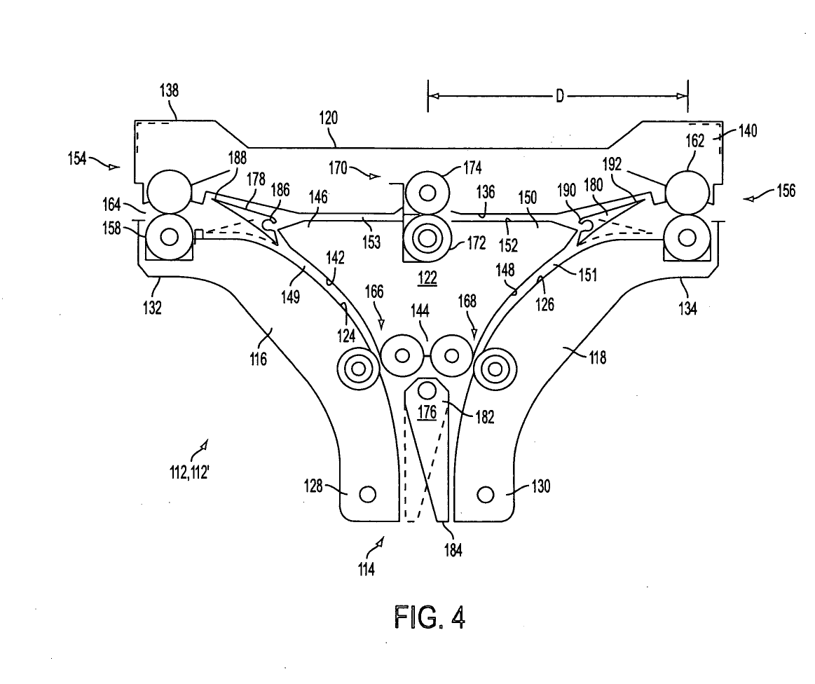

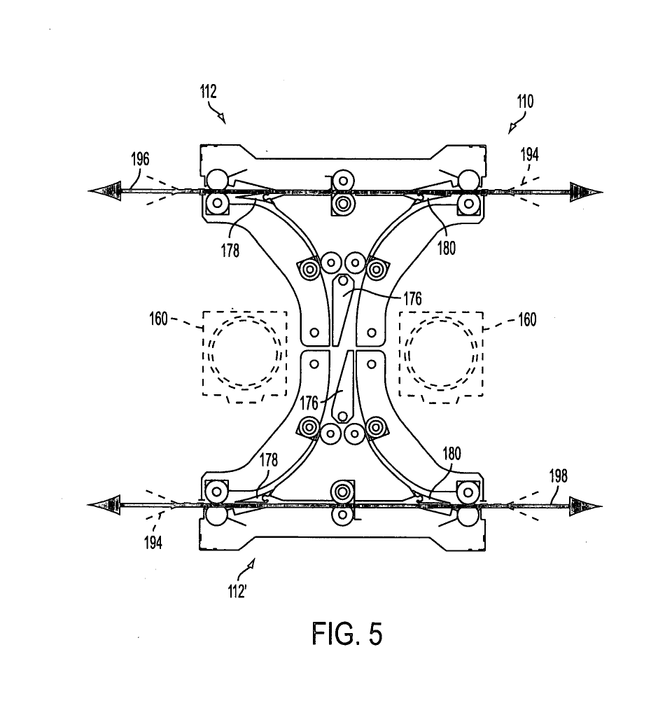

A media handling transport 110 in accordance with the present disclosure comprises two, substantially identical, device halves 112, 112′. As shown in FIGS. 5-8, the device halve 112, 112′ are mounted together with the abutting end 114 of a first device half 112 disposed adjacent the abutting end 114 of a second device half 112′. As shown in FIG. 4, each device half 112, 112′ includes three outer body members (first and second side body members 116, 118 and upper/lower body member 120), and an inner body member 122. To facilitate discussion, the device half 112, 112′ will be discussed in the orientation shown in FIG. 4, although it should be understood that the media handling transport 110 may be installed in any orientation.

The first and second side body members 116, 118 are substantially identical and are made of any suitable, durable material. Each side body member 116, 118 has an inner surface 124, 126, extending from a lower or abutting end portion 128, 130 to an upper end portion 132, 134, that forms a guide having a smooth uniform surface such that a leading edge of a sheet is not stubbed or caught by a portion of the inner surface 124, 126. In the embodiment shown in FIG. 4, inner surfaces 124, 126 have an arcuate shape optimized to change the direction of travel of a sheet ninety degrees. The upper/lower body member 120 has an inner surface 136, extending horizontally from a first end portion 138 associated with the upper end portion 132 of the first side body member 116 to a second end portion 140 associated with the upper end portion 134 of the second side body member 118. Inner surface 136 also forms a guide having a smooth uniform surface such that a leading edge of a sheet is not stubbed or caught by a portion of the inner surface 136. In the embodiment shown in FIG. 4, inner surface 136 has a substantially horizontal shape optimized to maintain the direction of travel of a sheet. The inner body member 122 has a first guide surface 142 extending from a lower end portion 144 to a first upper end portion 146, a second guide surface 148 extending from the lower end portion 144 to a second upper end portion 150, and a third guide surface 152 extending horizontally from the first upper end portion 146 to the second upper end portion 150. The first, second and third guide surfaces 142, 148, 152 each have a smooth uniform surface such that a leading edge of a sheet is not stubbed or caught by a portion of the guide surface. The first, second and third guide surfaces 142, 148, 152 are disposed opposite to inner surface 124, inner surface 126 and inner surface 136, respectively, have shapes complementary thereto, and define first, second and third paper transport passageways 149, 151, 153 therebetween.

Each device half 112, 112′ includes a first feed mechanism 154, associated with the upper end portion 132 of the first side body member 116 and the first end portion 138 of the upper/lower body member 120, and a second feed mechanism 156, associated with the upper end portion 134 of the second side body member 118 and the second end portion 140 of the upper/lower body member 120. The feed mechanisms 154, 156 may take the form of any feed mechanism capable of advancing the sheet. For example, the feed mechanism 154, 156 may be in the form of a drive roll 158 rotated by a motor 160 and a driven roll 162. The sheet is drawn in the direction of travel at a nip 164 between the drive roll 158 and the driven roll 162. The drive roll 158 and driven roll 162 may be rotatably mounted in the upper end portion 132, 134 of the side body member 116, 118 and the end portion 138, 140 of the upper/lower body member 120, respectively (as shown in FIG. 4). Alternatively, the drive roll 158 and driven roll 162 may be rotatably mounted in the end portion 138, 140 of the upper/lower body member 120 and the upper end portion 132, 134 of the side body member 116, 118, respectively.

Each device half 112, 112′ also includes a first drive mechanism 166, associated with the lower end portion 144 of the inner body member 122 and inner surface 124, a second drive mechanism 168, associated with the lower end portion 144 of the inner body member 122 and inner surface 126, and a third drive mechanism 170, associated with inner surface 136 and guide surface 152. The drive mechanisms 166, 168. 170 may take the form of any drive mechanism capable of advancing the sheet. For example, the drive mechanism 166, 168. 170 may be in the form of a drive roll 172 rotated by a motor 160 and a driven roll 174. The sheet is drawn in the direction of travel at a nip between the drive roll 172 and the driven roll 174. The drive roll 172 and driven roll 174 may be rotatably mounted in the side body member 116, 118 and the lower end portion 144 of the inner body member 122, respectively (as shown in FIG. 4). Alternatively, the drive roll 172 and driven roll 174 may be rotatably mounted in the lower end portion 144 of the inner body member 122 and the side body member 116, 118, respectively. The distance D between either feed mechanism 154, 156 and a drive mechanism 166, 168, 170 is dictated by the minimum length of the media that will be utilized in the copying system 10. Drive motors 160 connected to the drive mechanisms 166, 168, 170 and feed mechanisms 154, 156 are controlled to advance, retract, or hold a sheet of media as directed by the controller. The controller may also control the speed of the drive motors 160.

Each device half 112, 112′ further includes three diverters 176, 178, 180 for selectively directing the sheets as they pass through the media handling transport 110. Each diverter 176, 178, 180 may have any suitable configuration capable of selectively directing the sheet. In the examples shown in FIGS. 4-9, the diverters 176, 178, 180 are in the form of pivotable levers that are positively and selectively positioned in either a first diverter position or a second diverter position by a series of solenoids, cams and/or other positioning devices. The first diverter 176 is positioned below the lower end portion 144 of the inner body member 122, between the first and second side body members 116, 118. The first diverter 176 extends from a first end portion 182, pivotally mounted proximate to the lower end portion 144 of the inner body member 122, to a free end 184 disposed adjacent the abutting end 114 of the device half 112, 112′. The second diverter 178 extends from a first end portion 186, pivotally mounted proximate to the inner body member 122 first upper end portion 146, to a free end 188 disposed proximate to the first feed mechanism 154. The third diverter 180 extends from a first end portion 190, pivotally mounted proximate to the inner body member 122 second upper end portion 150, to a free end 192 disposed proximate to the second feed mechanism 156.

As described above, the media handling transport 110 is formed by mounting two device halves 112, 112′ together, with the abutting end 114 of a first device half 112 disposed adjacent the abutting end 114 of a second device half 112′ and the second device 112′ half being a “mirror image” of the first device half 112. The lower end portions 128, 130 of the side body members 116, 118 are pivotally mounted to facilitate access to the passageways between the side body member 116, 118 and the inner body member 122 in the event of a paper jam.

The direction of sheet transport through an electrophotographic copying system 10 is easily controlled by the positioning of the three diverters 176, 178, 180 of each device half 112, 112′ of the media handling transport 110. Baffles 194 are positioned adjacent the first and second feed mechanisms 154, 156, forming a chute at the entrance/exit of each device half 112, 112′. The baffles 194 are mounted in a manner that allows for modularity to facilitate multi-use within a printer racetrack. The entry or exit angle defined by the baffles depends on the amount of media curl allowed by specification.

FIG. 5 illustrates the positioning of the diverters 178, 180 when the media handling transport 110 is operating in a first configuration. In this configuration, the second and third diverters 178, 180 of either the first device half 112 or the second device half 112′ are in the second diverter position. Positioning the diverters 178, 180 in this manner creates an straight-through flow path through the media handling transport 110, where paper entering the first device half 112 passes through the media handling transport 110 on the upper flow path 196, and paper entering the second device half 112 passes through the media handling transport 110 on the lower media flow path 198.

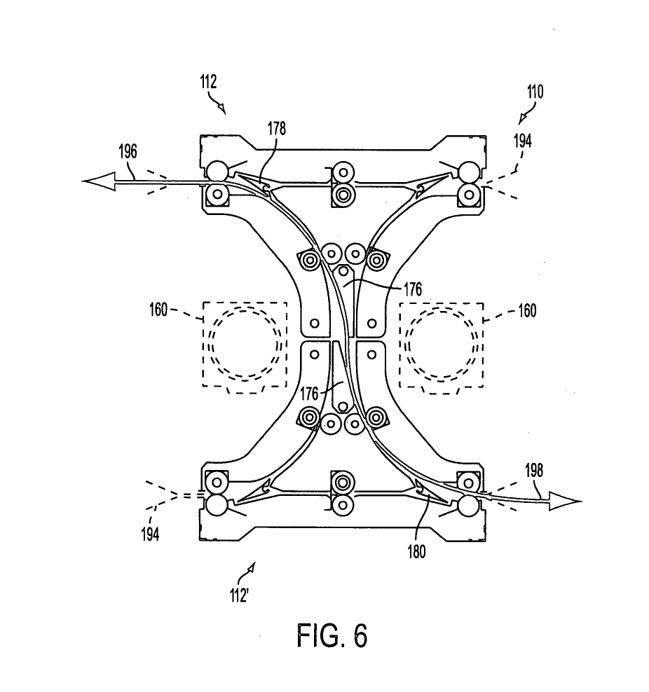

FIG. 6 illustrates the positioning of the diverters 176, 178, 180 when the media handling transport 110 is operating in a second configuration. In this configuration, the first diverter 176 of the first device half 112 is in the first diverter position (free end 184 positioned adjacent the second side body member inner surface 126, solid line FIG. 4) and the second diverter 178 of the first device half 112 is in the first diverter position (free end 188 positioned adjacent the upper/lower body member inner surface 136, solid line FIG. 4). In the mirror image second device half 112′, the first diverter 176 is in the second diverter position (free end 184 positioned adjacent the first side body member inner surface 124, dotted line FIG. 4) and the third diverter 180 in the first diverter position (free end 192 positioned adjacent the upper/lower body member inner surface 136, solid line FIG. 4). As shown in FIG. 6, positioning the diverters 176, 178, 180 in this manner creates an S-shaped flow path through the media handling transport 110 that shifts sheet flow between an upper media flow path 196 and a lower media flow path 198. The positions of the third diverter 180 of the first device half 112 and the second diverter 178 of the second device half 112′ are irrelevant, since neither diverter are in the media flow path.

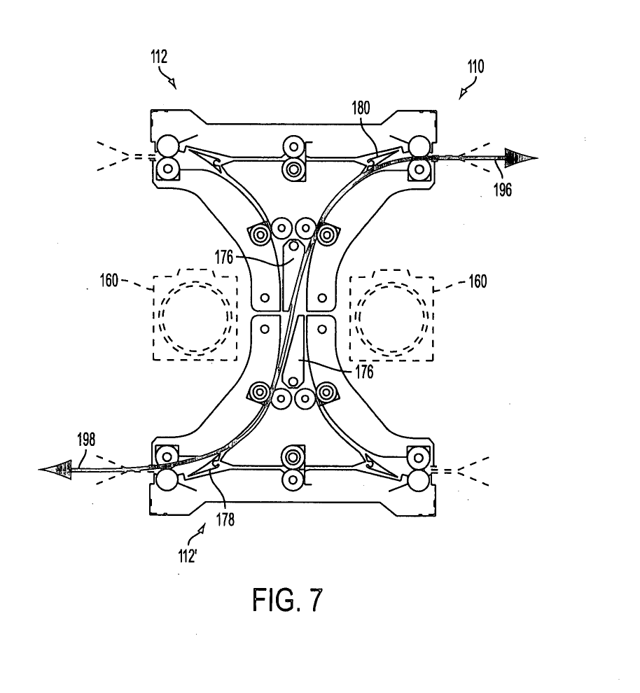

FIG. 7 illustrates the positioning of the diverters when the media handling transport is operating in a third configuration. In this configuration, the third diverter 180 of the first device half 112 is in the second diverter position, the second diverter 178 of the second device half 112′ is in the first diverter position, the first diverter 176 of the first device half 112 is in the second diverter position, and the first diverter 176 of the second device half 112′ is in the first diverter position. Positioning the diverters 176, 178, 180 in this manner creates an S-shaped flow path through the media handling transport 110 that shifts sheet flow between an upper media flow path 196 and a lower media flow path 198.

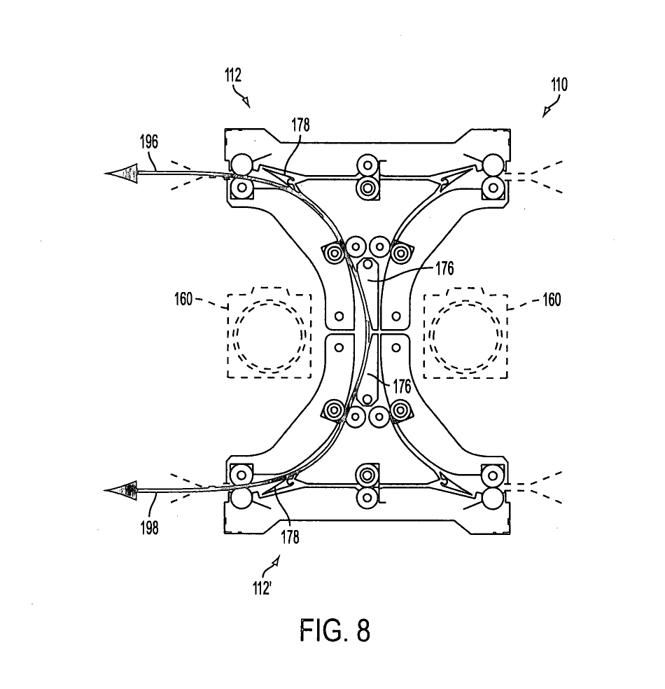

FIG. 8 illustrates the positioning of the diverters when the media handling transport 110 is operating in a fourth configuration. In this configuration, the second diverters 178 of both the first and second device halves 112, 112′ are in the first diverter position, the first diverter 176 of the first device half 112 is in the first diverter position, and the first diverter 176 of the second device half 112′ is in the second diverter position. Positioning the diverters 176, 178 in this manner creates a C-shaped flow path through the media handling transport 110 that reverses the direction of the media flow path and inverts the media.

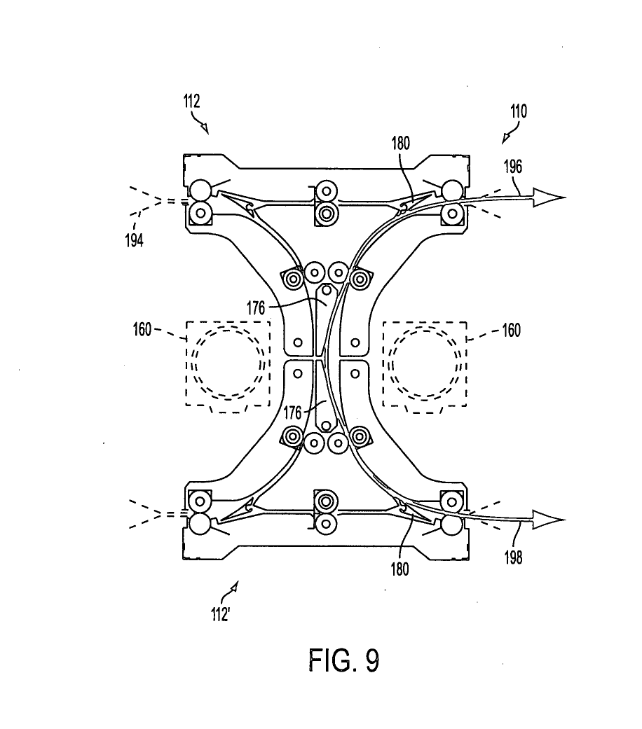

FIG. 9 illustrates the positioning of the diverters when the media handling transport 110 is operating in a fifth configuration. In this configuration, the first diverters 176 of both the first and second device halves 112, 112′ are in the second diverter position and the third diverters 180 of both the first and second device halves 112, 112′ are in the first position. Positioning the diverters 176, 180 in this manner creates a C-shaped flow path through the media handling transport 110 that reverses the direction of the media flow path and inverts the media.

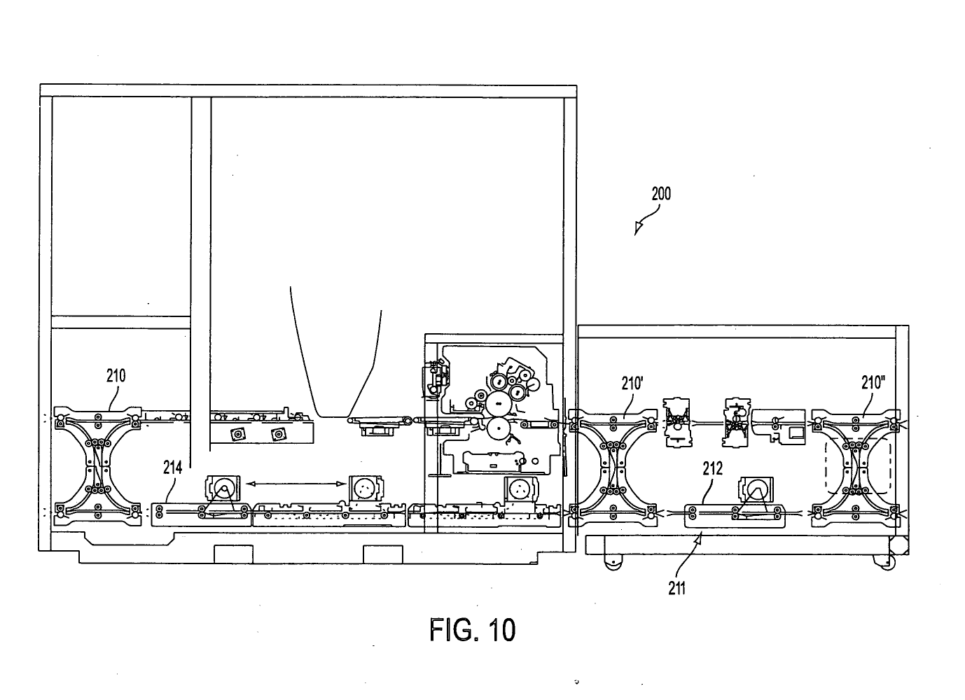

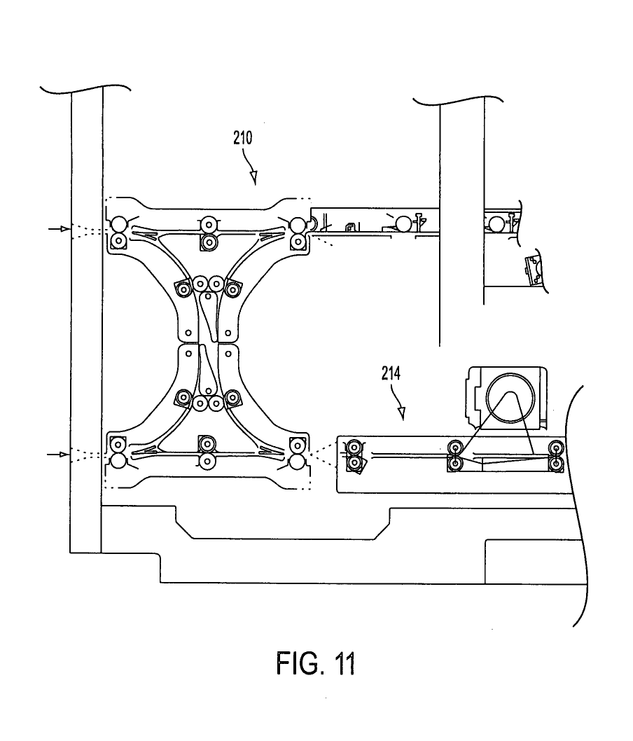

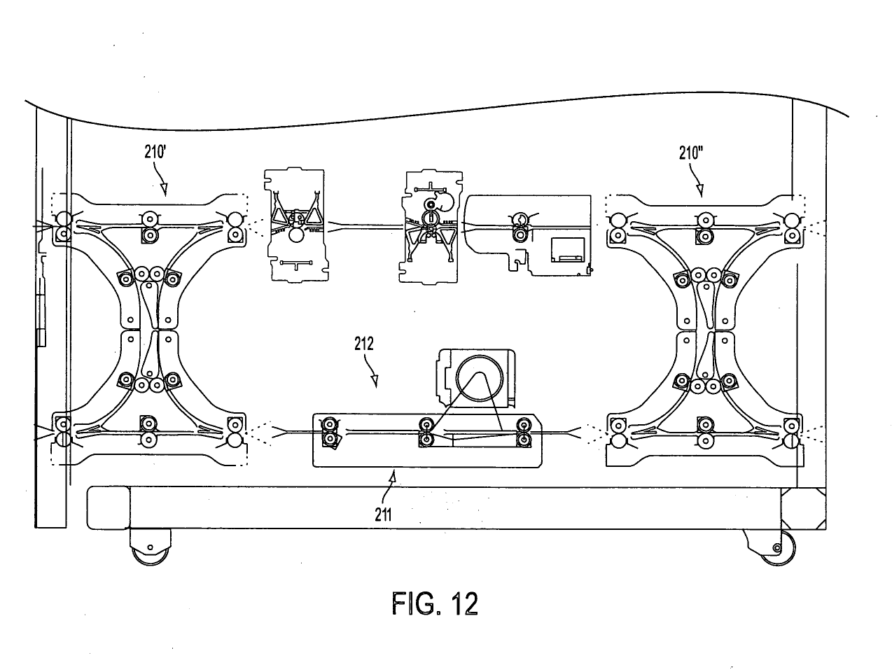

With reference to FIGS. 10, 11 and 12, the iGen3™ copying system can be easily converted to operate in both a tightly integrated parallel printer (TIPP) and tightly integrated serial printer (TISP) mode by modifying the duplex return paper path as a bi-directional paper path. Converting the duplex return paper path to a bi-direction paper path requires replacing the first, second and third media handling devices with first, second and third media handling transports 110. In addition, one nip horizontal transport must be added between the second and third media handling transports 110, 110′, 110″ and another nip horizontal transport replaces the sloping duplex transport of the first media handling device.

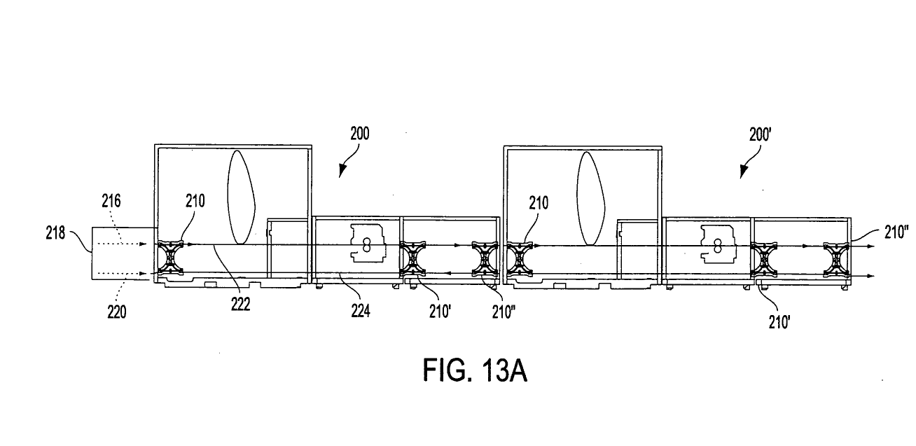

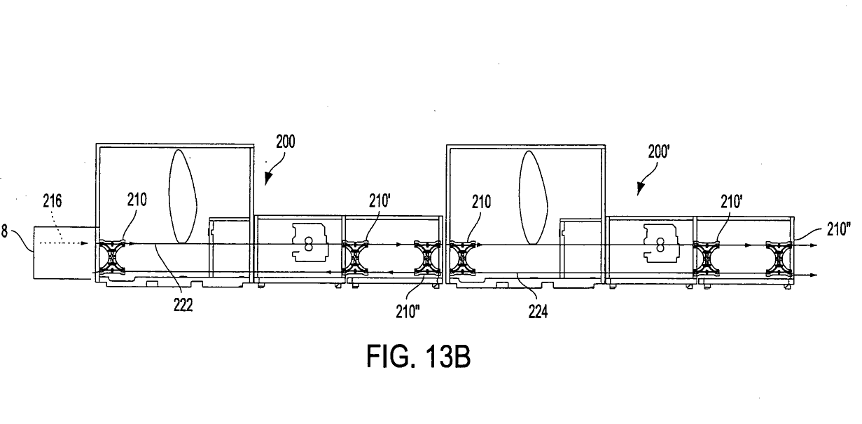

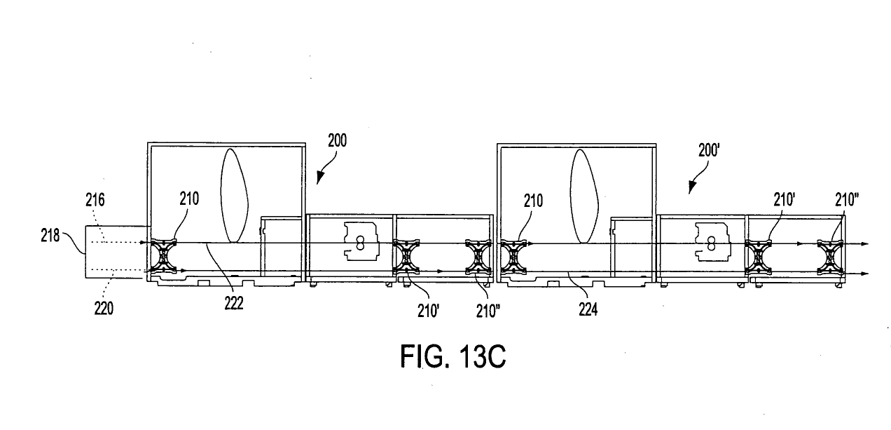

As described above, each media handling transport 110 has five modes of operation. Accordingly, replacing the three handling devices utilized in the conventional iGen3™ copying system with three media handling transports 110, 110′, 110″ produces a copying system that has great flexibility of operation. This flexibility of operation is further increased when two copying systems are installed in tandem, as shown in FIGS. 13a-13c.

FIG. 13a shows the two copying systems operating in a Duplex Tandem mode of operation. In this mode of operation, the first media handling transport 110 of the first copying system is set to either the first configuration (FIG. 5), to receive sheet material from an upper tray of a sheet material supply device, or in the third configuration (FIG. 7) to receive sheet material from a lower tray of the sheet material supply device. In either configuration, the sheet material is directed to the upper media flow path 196. The second media handling transport 110′ of the first copying system is set to operate in the first configuration (FIG. 5) to either direct sheet material to the third media handling device 110″ in the upper media flow path 196 or to the first media handling transport 110 in the lower media flow path 198. The third media handling transport 110″ of the first copying system is set to operate in either the first configuration (FIG. 5), directing the sheet material along the upper media flow path 196 to the first media handling transport 110 of the second copying system, or the fourth configuration (FIG. 8), directing the sheet material back to the second media handling transport 110′ along the lower media flow path 198. The first and second media handling transports 110, 110′ of the second copying system are each operated in the first configuration (FIG. 5), directing sheet material along the upper media flow path 196 to the third media handling transport 110″. The third media handling transport 110″ of the second copying system is operated in either the first configuration (FIG. 5) to direct the sheet material out of the second copying system along the upper media flow path 196, or in the second configuration (FIG. 6) to direct the sheet material out of the second copying system along the lower media flow path 198.

FIG. 13b shows the two copying systems operating in a Duplex Standalone mode of operation. In this mode of operation, the first media handling transport 110 of the first copying system is initially set to the first configuration (FIG. 5), to receive sheet material from an upper tray of the sheet material supply device and direct the sheet material to the second media handling transport 110′ along the upper media flow path 196. The second media handling transport 110′ of the first copying system is set to operate in the fourth configuration (FIG. 8), directing the sheet material back to the first media handling transport 110′ along the lower media flow path 198. The first media handling transport 110 is reset to the fifth configuration (FIG. 9) directing the sheet material to the second media handling transport 110′ along the upper media flow path 196.

FIG. 13c shows the two copying systems operating in a Simplex Bypass mode of operation. In this mode of operation, the first media handling transport 110 of the first copying system is set to either the first configuration (FIG. 5), to receive sheet material from a lower tray of the sheet material supply device, or in the second configuration (FIG. 6) to receive sheet material from an upper tray of the sheet material supply device. In either configuration, the sheet material is directed to the lower media flow path 198. The second media handling transport 110′ of the first copying system is set to operate in the first configuration (FIG. 5) to direct sheet material along the lower media flow path 198 to the third media handling transport 110″. The third media handling transport 110″ of the first copying system is operated in the third configuration (FIG. 7) to direct the sheet material from the lower media flow path 198 to the upper media flow path 196 and out of the first copying system. The first media handling transport 110 of the second copying system is set to the first configuration (FIG. 5), to receive sheet material from the first copying system and direct the sheet material along the upper media flow path 196 to the second media handling transport 110′. The second media handling transport 110′ of the second copying system is set to operate in the first configuration (FIG. 5) to direct sheet material along the upper media flow path 196 to the third media handling transport 110″. The third media handling transport 110″ of the second copying system is operated in either the first configuration (FIG. 5) to direct the sheet material out of the second copying system along the upper media flow path 196, or in the second configuration (FIG. 6) to direct the sheet material out of the second copying system along the lower media flow path 198.

The media handling transports 110 are sized to fit within the free space left within the copying system after the media handling devices are removed. It should be understood that the operating software of the copying system controller must be modified to control the media handling transports 110.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electrophotographic printing machine comprising:
at least one print engine;
an input media path delivering a print media to the print engine;
an output media path removing the print media from the print engine; and
a media handling transport disposed in at least one of the media paths, the media handling transport comprising first and second device halves, each of the device halves including
a first body member extending from a first end portion to a second end portion;
a second body member extending from a first end portion to a second end portion, the first end portion of the second body member being disposed adjacent the first end portion of the first body member;
a third outer body member extending from a first end portion to a second end portion, the first end portion of the third body member being disposed adjacent the second end portion of the first body member and the second end portion of the third body member being disposed adjacent the second end portion of the second body member; and
an inner body member disposed intermediate the first, second and third outer body members, the inner body member and the second body member defining a first media transport passageway, the inner body member and the third body member defining a second media transport passageway, and the inner body member and the first body member defining a third media transport passageway;
wherein the second end portions of the second and third body members defining an abutting end of the device half, the abutting end of the first device half being disposed adjacent the abutting end of the second device half.

2. The electrophotographic printing machine of claim 1 wherein the first, second and third body members each have an inner surface extending from the first end portion to the second end portion, each of the inner surfaces defining a guide having a substantially smooth uniform surface.

3. The electrophotographic printing machine of claim 2 wherein the inner surfaces of the second and third body members each have an arcuate shape to change a direction of travel of a sheet of media substantially ninety degrees.

4. The electrophotographic printing machine of claim 3 wherein the inner surface of the first body member has a substantially planar shape to maintain the direction of travel of a sheet of media.

5. The electrophotographic printing machine of claim 2 wherein the inner body member has a first guide surface extending from a lower end portion to a first upper end portion, a second guide surface extending from the lower end portion to a second upper end portion, and a third guide surface extending from the first upper end portion to the second upper end portion, the first, second and third guide surfaces being disposed opposite to the inner surfaces of the first, second and third body members, respectively and defining the first, second and third media transport passageways therebetween.

6. The electrophotographic printing machine of claim 5 wherein the first, second and third guide surfaces each have a substantially smooth uniform surface.

7. The electrophotographic printing machine of claim 5 wherein each device half further includes:
a first feed mechanism associated with the first end portion of the first body member and the first end portion of the second body member; and
a second feed mechanism associated with the second end portion of the first body member and the first end portion of the third body member.

8. The electrophotographic printing machine of claim 7 wherein each device half further includes:
a first drive mechanism associated with the lower end portion of the inner body member and the inner surface of the second body member; and
a second drive mechanism associated with the lower end portion of the inner body member and the inner surface of the third body member.

9. The electrophotographic printing machine of claim 8 wherein each device half further includes a third drive mechanism associated with the inner surface of the first body member and the first guide surface of the inner body member.

10. The electrophotographic printing machine of claim 9 wherein each device half further includes:
a first diverter extending from a first end portion pivotally mounted proximate to the inner body member lower end portion to a free end disposed adjacent the abutting end of the device half;
a second diverter extending from a first end portion pivotally mounted proximate to the inner body member first upper end portion to a free end disposed proximate to the first feed mechanism; and
a third diverter extending from a first end portion pivotally mounted proximate to the inner body member second upper end portion to a free end disposed proximate to the second feed mechanism;
wherein the free end portion of each of the diverters is selectively movable between a first diverter position or a second diverter position by a positioning device.

11. The electrophotographic printing machine of claim 10 further comprising a controller in communication with the feed mechanisms, the drive mechanisms and the diverters.

12. The electrophotographic printing machine of claim 11 further comprising:
a first baffle disposed adjacent the first feed mechanisms; and
a second baffle disposed adjacent the second feed mechanism.

13. An electrophotographic printing machine comprising:
at least one print engine;
an input media path delivering a print media to the print engine;
an output media path removing the print media from the print engine; and
a media handling transport disposed in at least one of the media paths, the media handling transport including
an upper body member having an inner surface extending from a first end portion to a second end portion;
a lower body member having an inner surface extending from a first end portion to a second end portion;
a first side body member having an inner surface extending from a upper end portion to a lower end portion, the upper end portion of the first side body member being disposed adjacent the first end portion of the upper body member and the lower end portion of the first side body member being disposed adjacent the first end portion of the lower body member;
a second side body member having an inner surface extending from a upper end portion to a lower end portion, the upper end portion of the second side body member being disposed adjacent the second end portion of the upper body member and the lower end portion of the second side body member being disposed adjacent the second end portion of the lower body member;
a first inner body member having a first guide surface extending from a lower end portion to a first upper end portion, a second guide surface extending from the lower end portion to a second upper end portion, and a third guide surface extending from the first upper end portion to the second upper end portion, the first guide surface and the first side body member inner surface defining a first media transport passageway segment, the second guide surface and the second side body member inner surface defining a second media transport passageway segment, and the third guide surface and the upper body member inner surface defining a first media transport passageway;
a second inner body member having a first guide surface extending from an upper end portion to a first lower end portion, a second guide surface extending from the upper end portion to a second lower end portion, and a third guide surface extending from the first lower end portion to the second lower end portion, the first guide surface and the first side body member inner surface defining a third media transport passageway segment, the second guide surface and the second side body member inner surface defining a fourth media transport passageway segment, and the third guide surface and the lower body member inner surface defining a second media transport passageway;
a first diverter extending downwardly from a first end portion pivotally mounted proximate to the first inner body member lower end portion to a free end;
a second diverter extending upwardly from a first end portion pivotally mounted proximate to the second inner body member upper end portion to a free end;
wherein the free end portions of the first and second diverters are independently selectively movable between a first diverter position or a second diverter position whereby a sheet of media may be directed from the first media transport passageway segment to the third media transport passageway segment, from the first media transport passageway segment to the fourth media transport passageway segment, from the third media transport passageway segment to the first media transport passageway segment, from the third media transport passageway segment to the second media transport passageway segment, from the second media transport passageway segment to the third media transport passageway segment, from the second media transport passageway segment to the fourth media transport passageway segment, from the fourth media transport passageway segment to the first media transport passageway segment, or from the fourth media transport passageway segment to the second media transport passageway segment.

14. A kit to convert a conventional electrophotographic copying or printing system to an electrophotographic copying or printing system that operates in a tightly integrated parallel printer mode or a tightly integrated serial printer mode comprises a media handling transport adapted to replace at least one media handling device of the conventional electrophotographic copying or printing system, the media handling transports comprising:
an upper body member having an inner surface extending from a first end portion to a second end portion;
a lower body member having an inner surface extending from a first end portion to a second end portion;
a first side body member having an inner surface extending from a upper end portion to a lower end portion, the upper end portion of the first side body member being disposed adjacent the first end portion of the upper body member and the lower end portion of the first side body member being disposed adjacent the first end portion of the lower body member;
a second side body member having an inner surface extending from a upper end portion to a lower end portion, the upper end portion of the second side body member being disposed adjacent the second end portion of the upper body member and the lower end portion of the second side body member being disposed adjacent the second end portion of the lower body member;
a first inner body member having a first guide surface extending from a lower end portion to a first upper end portion, a second guide surface extending from the lower end portion to a second upper end portion, and a third guide surface extending from the first upper end portion to the second upper end portion, the first guide surface and the first side body member inner surface defining a first media transport passageway segment, the second guide surface and the second side body member inner surface defining a second media transport passageway segment, and the third guide surface and the upper body member inner surface defining a first media transport passageway;
a second inner body member having a first guide surface extending from an upper end portion to a first lower end portion, a second guide surface extending from the upper end portion to a second lower end portion, and a third guide surface extending from the first lower end portion to the second lower end portion, the first guide surface and the first side body member inner surface defining a third media transport passageway segment, the second guide surface and the second side body member inner surface defining a fourth media transport passageway segment, and the third guide surface and the lower body member inner surface defining a second media transport passageway;
a first diverter extending downwardly from a first end portion pivotally mounted proximate to the first inner body member lower end portion to a free end;
a second diverter extending upwardly from a first end portion pivotally mounted proximate to the second inner body member upper end portion to a free end;
wherein the free end portions of the first and second diverters are independently selectively movable between a first diverter position or a second diverter position whereby a sheet of media may be directed from the first media transport passageway segment to the third media transport passageway segment, from the first media transport passageway segment to the fourth media transport passageway segment, from the third media transport passageway segment to the first media transport passageway segment, from the third media transport passageway segment to the second media transport passageway segment, from the second media transport passageway segment to the third media transport passageway segment, from the second media transport passageway segment to the fourth media transport passageway segment, from the fourth media transport passageway segment to the first media transport passageway segment, or from the fourth media transport passageway segment to the second media transport passageway segment.

15. The kit of claim 14 wherein the media handling transport further comprises:
a first feed mechanism associated with the first end portion of the upper body member and the upper end portion of the first side body member;
a second feed mechanism associated with the second end portion of the upper body member and the upper end portion of the second side body member;
a third feed mechanism associated with the first end portion of the lower body member and the lower end portion of the first side body member; and
a fourth feed mechanism associated with the second end portion of the lower body member and the lower end portion of the second side body member.

16. The kit of claim 15 wherein the media handling transport further comprises:
a first drive mechanism associated with the first media transport passageway;
a second drive mechanism associated with the second media transport passageway;
a third drive mechanism associated with the first media transport passageway segment;
a fourth drive mechanism associated with the second media transport passageway segment;
a fifth drive mechanism associated with the third media transport passageway segment; and
a sixth drive mechanism associated with the fourth media transport passageway segment.

17. The kit of claim 16 wherein the media handling transport further comprises:
a third diverter disposed intermediate the first inner body member first upper end portion, the upper body member, and the first side body member;
a fourth diverter disposed intermediate the first inner body member second upper end portion, the upper body member, and the second side body member;
a fifth diverter disposed intermediate the second inner body member first lower end portion, the lower body member, and the first side body member; and
a sixth diverter disposed intermediate the second inner body member second lower end portion, the lower body member, and the second side body member.

18. The kit of claim 14, wherein a one of the media handling transports replaces each of the media handling devices of the conventional electrophotographic copying or printing system.

19. The kit of claim 18 further comprising at least one nip horizontal transport.

20. A method of converting a conventional electrophotographic copying or printing system to an electrophotographic copying or printing system that operates in a tightly integrated parallel printer mode or a tightly integrated serial printer mode, the conventional electrophotographic copying or printing system having a plurality of media handling devices, the method comprising replacing each of the media handling devices with a media handling transport, the media handling transport including
an upper body member having an inner surface extending from a first end portion to a second end portion;
a lower body member having an inner surface extending from a first end portion to a second end portion;
a first side body member having an inner surface extending from a upper end portion to a lower end portion, the upper end portion of the first side body member being disposed adjacent the first end portion of the upper body member and the lower end portion of the first side body member being disposed adjacent the first end portion of the lower body member;
a second side body member having an inner surface extending from a upper end portion to a lower end portion, the upper end portion of the second side body member being disposed adjacent the second end portion of the upper body member and the lower end portion of the second side body member being disposed adjacent the second end portion of the lower body member;
a first inner body member having a first guide surface extending from a lower end portion to a first upper end portion, a second guide surface extending from the lower end portion to a second upper end portion, and a third guide surface extending from the first upper end portion to the second upper end portion, the first guide surface and the first side body member inner surface defining a first media transport passageway segment, the second guide surface and the second side body member inner surface defining a second media transport passageway segment, and the third guide surface and the upper body member inner surface defining a first media transport passageway;
a second inner body member having a first guide surface extending from an upper end portion to a first lower end portion, a second guide surface extending from the upper end portion to a second lower end portion, and a third guide surface extending from the first lower end portion to the second lower end portion, the first guide surface and the first side body member inner surface defining a third media transport passageway segment, the second guide surface and the second side body member inner surface defining a fourth media transport passageway segment, and the third guide surface and the lower body member inner surface defining a second media transport passageway;
a first diverter extending downwardly from a first end portion pivotally mounted proximate to the first inner body member lower end portion to a free end;
a second diverter extending upwardly from a first end portion pivotally mounted proximate to the second inner body member upper end portion to a free end;
wherein the free end portions of the first and second diverters are independently selectively movable between a first diverter position or a second diverter position whereby a sheet of media may be directed from the first media transport passageway segment to the third media transport passageway segment, from the first media transport passageway segment to the fourth media transport passageway segment, from the third media transport passageway segment to the first media transport passageway segment, from the third media transport passageway segment to the second media transport passageway segment, from the second media transport passageway segment to the third media transport passageway segment, from the second media transport passageway segment to the fourth media transport passageway segment, from the fourth media transport passageway segment to the first media transport passageway segment, or from the fourth media transport passageway segment to the second media transport passageway segment.

21. The method of claim 20 wherein the conventional electrophotographic copying or printing system has first, second and third media handling devices, the method further comprising installing a lower media flow path and a first nip horizontal transport between the second and third media handling transports.

22. The method of claim 21 further comprising replacing a sloping duplex transport of the first media handling device with a second nip horizontal transport.
